(19) United States
(12) Patent Application Publication
(10) Pub. No.: US 2007/0076240 A1
(43) Pub. Date: Apr. 5, 2007

(54) Image processing system

(75) Inventor: Kazuhiro Ogura, Fujisawa-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/242,056

(22) Filed: Oct. 4, 2005

(51) Int. Cl. G06K 15/00

(52) U.S. Cl. 358/1.14; 358/1.15

(57) ABSTRACT

An image processing apparatus performs user authentication, and the user whose authentication has succeeded selects document data to which an image is to be appended from document data which are being edited by that user or templates of document data that can be used by the user. An image of a document is scanned while the user selects the document data, and image data of the scanned image is attached to the document data selected by the user.

### BACKGROUND OF THE INVENTION

1. Field of the Invention

The present invention relates to an image processing apparatus, image processing system, and image processing method, which create, for example, document data attached with image data obtained by scanning an image of a document.

2. Description of the Related Art

In recent years, a data processing system which digitizes documents such as application forms, reports, and the like has been proposed. For example, Jpn. Pat. Appln. KOKAI Publication No. 2003-303276 describes a system which makes final decision on the basis of image data of documents scanned by a scanner.

Jpn. Pat. Appln. KOKAI Publication No. 2003-303276 describes a system comprising a scanner, bill management server, master copy management database, bill management database, and the like is pasted. In this system, the scanner scans an image on a board on which a document such as a check or the like. The scanner generates an image file and management file of the scanned image. The scanner encrypts the generated image file and management file. The scanner stores the encrypted image file and management file in the master copy management database. The bill management server associates a bill record stored in the bill management database with the image file in the master copy management database.

However, with the technique described in Jpn. Pat. Appln. KOKAI Publication No. 2003-303276, a method of specifying a bill associated with the scanned image is complicated.

### BRIEF SUMMARY OF THE INVENTION

An image processing apparatus according to one aspect of the present invention comprises a user authentication unit which authenticates a user, a list acquisition unit which acquires a list of document data which are configured to be selected by the user whose authentication by the user authentication unit has succeeded, an image acquisition unit which acquires, when one document data is selected from the list of document data acquired by the list acquisition unit, image data to be attached to the selected document data, and a registration unit which registers the image data acquired by the image acquisition unit as attachment data of the selected document data.

An image processing system according to one aspect of the present invention is a system having an image processing apparatus and a terminal which is configured to communicate with the image processing apparatus, the image processing apparatus comprising a user authentication unit which authenticates a user, a list acquisition unit which acquires a list of document data which are configured to be selected by the user whose authentication by the user authentication unit has succeeded, an image acquisition unit which acquires, when one document data is selected from the list of document data acquired by the list acquisition unit, image data to be attached to the selected document data, an encryption unit which encrypts a region to be encrypted notified by the terminal on the image data acquired by the image acquisition unit, and a registration unit which registers the image data encrypted by the encryption unit as attachment data of the selected document data, and the terminal comprising an operation unit to accept designation of a region to be encrypted on the image data which is acquired by the image processing apparatus using the image acquisition unit, and a processing unit which notifies the image processing apparatus of the region to be encrypted designated by the operation unit.

An image processing method according to one aspect of the present invention comprises authenticating a user, acquiring a list of document data which are configured to be selected by the user whose authentication has succeeded, acquiring, when one document data is selected from the acquired list of document data, image data to be attached to the selected document data, and registering the acquired image data as attachment data of the selected document data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the overall arrangement of a data processing system according to an embodiment of the present invention;

FIG. 2 is a schematic block diagram showing an example of the hardware arrangement of a digital multi-functional peripheral as an image processing apparatus;

FIG. 3 is a block diagram showing an example of the functional arrangement of an image processing apparatus 1 for implementing the data processing system according to the embodiment of the present invention;

FIG. 4 is a flowchart for explaining a first processing example in the digital multi-functional peripheral as the image processing apparatus;

FIG. 5 is a flowchart for explaining the first processing example in the digital multi-functional peripheral as the image processing apparatus;

FIG. 6 shows a display example of a user login window;

FIG. 7 shows a display example of an operation window for the login user;

FIG. 8 shows a display example of a list of document data, which is being edited by the login user;

FIG. 9 shows a display example of a scan setting window;

FIG. 10 shows a display example of a selection window of a mask region;

FIG. 11 shows a logical data structure of image data which has undergone encryption, apparatus signature, and user signature;

FIG. 12 shows a physical data structure of image data which has undergone encryption, apparatus signature, and user signature;

FIG. 13 is a flowchart for explaining a second processing example in the digital multi-functional peripheral as the image processing apparatus;

FIG. 14 is a flowchart for explaining the second processing example in the digital multi-functional peripheral as the image processing apparatus;

FIG. 15 shows a display example of a list of templates as document data which can be used by the login user;

FIG. 16 is a flowchart for explaining processing executed when a mask region is designated for image data saved in a data storage server at a terminal; and

FIG. 17 shows a display example of an encryption region designation window displayed on a display unit of the terminal.

### DETAILED DESCRIPTION OF THE INVENTION

Preferred embodiments according to the present invention will be described below with reference to the accompanying drawings.

A data processing system according to the embodiment of the present invention will be described first.

FIG. 1 is a schematic diagram showing the overall arrangement of the data processing system.

As shown in FIG. 1, in the data processing system an image processing apparatus 1, data storage server 2, data management server 3, and terminal 4 are connected via a network 5. Note that the data management server 3 and data storage server 2 may be implemented by a single server apparatus.

The image processing apparatus 1 is implemented by, e.g., a digital multi-functional peripheral (MFP) or a scanner. The image processing apparatus 1 is used to create document data (e.g., text data, image data, and the like) used to make various applications or reports, as will be described later. The image processing apparatus 1 executes processing for acquiring image data, and attaching the acquired image data to document data which is being edited by the user or document data created based on a template selected by the user. That is, the image processing apparatus 1 executes processing for creating document data attached with an image. Note that the image processing apparatus 1 may have functions which can implement various kinds of processing to be described later.

The data storage server 2 is a server apparatus having a function of saving data such as image data and the like. The data storage server 2 saves document data created by the image processing apparatus 1 or document data edited on the terminal 4. The data storage server 2 also has a function of saving image data processed by the image processing apparatus 1 as attachment data of document data.

The data management server 3 is a server apparatus which manages document data used to make various applications or reports. The data management server 3 manages document data saved in the data storage server 2.

The terminal 4 is a device used by the user. The terminal 4 comprises, e.g., a personal computer (PC) or the like. The terminal 4 has a display unit 4a, operation unit 4b, and processing unit 4c. The display unit 4a comprises a display device. The operation unit 4b comprises an operation device such as a keyboard, mouse, or the like. The processing unit 4c comprises a CPU as a controller, various memories as a storage unit, a display controller for controlling the display unit 4a, an interface for the operation unit 4b, a communication interface for a network communication, and the like. The processing unit 4c has a function of executing various kinds of processing by executing application programs stored in the storage unit by the CPU or the like.

More specifically, in the data processing system shown in FIG. 1, the image processing apparatus 1 creates document data attached with image data. This document data is edited by the user as needed at the terminal 4 or the like. The document data created by the image processing apparatus 1 is stored in the data storage server 2. The document data stored in the data storage server 2 is managed by the data management server 3. With this arrangement, the data processing system as a whole realizes paperless (digitization) of various applications or reports.

A practical example of the management pattern of the data processing system will be described below.

The data processing system is a system which digitizes documents such as application forms or reports in an organization such as a company or the like.

In an organization such as a company or the like, an application form or report must be put forward by appending a certificate or the like to it. In such case, document data as an application form or report can be created by each user at the terminal 4. At the terminal 4, it is difficult to digitize an image such as a certificate or the like. The data processing system of this embodiment is a system which allows to easily attach an image of a document or the like to document data.

For example, upon fixing expenditures of a business trip, a person who made the business trip must put forward an application form that requests to fix the expenditures of the business trip by attaching documents such as receipts and the like indicating amounts spent actually. When a filed item must be changed (e.g., address change), the user puts forward an application form that requests to change the filed item by attaching a document that gives proof of the change contents to it. When the user applies to fix the purchase price of equipment, he or she must put forward an application form that requests to fix the purchase price of equipment by attaching a document indicating the purchase price to it.

In order to digitize the aforementioned application forms that require attachment of documents, the data processing system of this embodiment executes processing for attaching image data of a document to document data as an application form. That is, the document processing system of this embodiment attains a paperless environment of the application form, report, and the like that requires attachment of documents. In other words, the data processing system of this embodiment implements the workflow that attaches image data of documents such as receipts, certificate, and the like to digital data (document data) created as application forms or reports.

An example of the arrangement of the image processing apparatus 1 will be described below.

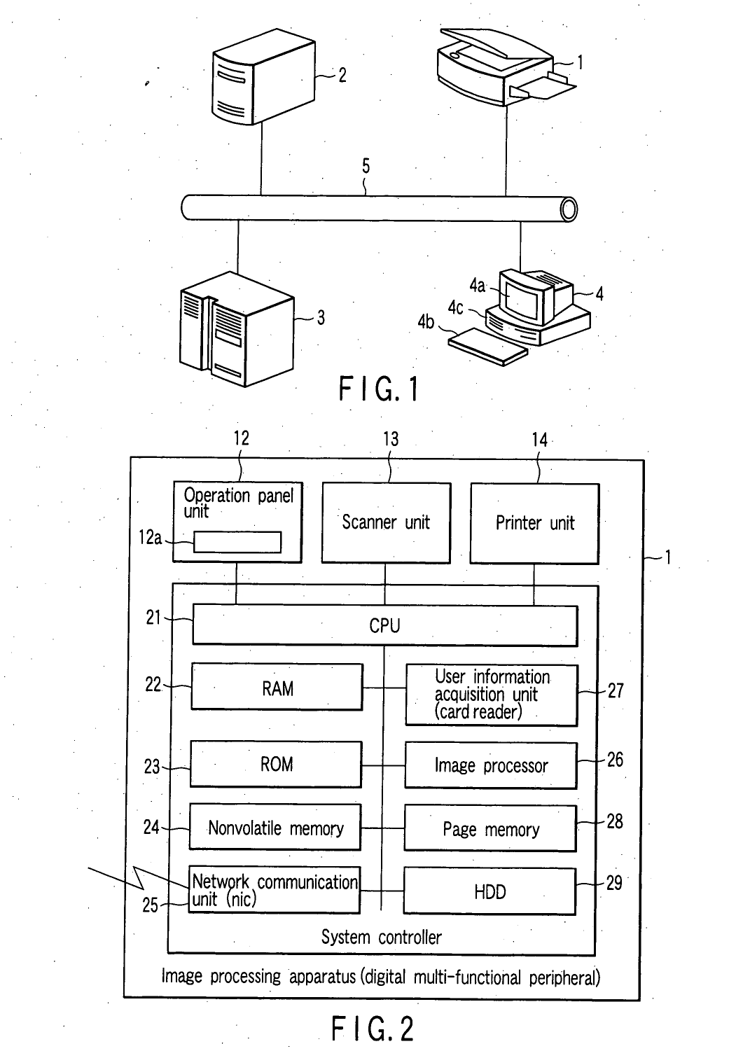

FIG. 2 is a schematic block diagram showing an example of the hardware arrangement of the digital MFP as the image processing apparatus 1.

As shown in FIG. 2, this digital MFP comprises a system controller 11, operation panel 12, scanner unit 13, printer unit 14, and the like.

The system controller 11 controls the overall digital MFP. The system controller 11 is connected to the operation panel 12, scanner unit 13, printer unit 14, and the like. With this arrangement, the system controller 11 implements a function of receiving operation instructions input to the operation panel 12, a function of controlling the scanner unit 13, and a function of controlling the printer unit 14.

The operation panel 12 is a user interface to which user's operation instructions are input. The operation panel 12 has hardware keys such as a numeric keypad and the like, and a display unit 12a such as a display device that incorporates a touch panel, or the like. The display unit 12a of the operation panel 12 displays operation guides, touch keys, and the like. The operation panel 12 detects inputs to the touch keys displayed on the display unit 12a by the touch panel. For example, setting information of various functions and the like designated by the user are input from the operation panel 12, and are supplied to the system controller 11.

The scanner unit 13 converts a document image into image data. The scanner unit 13 converts a document image into color or monochrome digital image data. The scanner unit 13 comprises a scanner (not shown) for optically scanning the document surface, a photoelectric converter (not shown) such as a CCD line sensor or the like that converts light reflected by the document surface optically scanned by the scanner into an electrical signal, and the like. The scanner unit 13 supplies digital image data as the scanned document image to the system controller 11.

The printer unit 14 forms an image on an image forming medium. The printer unit 14 comprises a convey unit (not shown) for conveying an image medium, an image forming unit (not shown) for forming a color image or monochrome image on the image forming medium conveyed by the convey unit, and the like. The printer unit 14 prints image data of respective pages on image forming media under the control of the system controller 11.

The system controller 11 comprises a CPU (Central Processing Unit) 21, RAM (Random Access Memory) 22, ROM (Read Only Memory) 23, nonvolatile memory 24, network communication unit 25, image processor 26, card reader 27, page memory 28, hard disk drive (HDD) 29, and the like.

The CPU 21 controls the overall system controller 11. The CPU 21 implements various kinds of processing and various functions when it operates based on control programs. To the CPU 21, the operation panel 12, scanner unit 13, printer unit 14, and the like are connected.

The RAM 22 is a memory which temporarily stores work data, and stores reference data. The ROM 23 is a nonvolatile memory. The ROM 23 stores, e.g., control programs, control data, and the like required to control the digital MFP 1. The nonvolatile memory 24 is a rewritable nonvolatile memory. The nonvolatile memory 24 comprises an EEPROM, flash ROM, or the like. The nonvolatile memory 24 stores system setting information and the like.

The network communication unit 25 controls data communications via the network 5. The network communication unit 25 comprises a network interface card (NIC) or the like required to connect the network 5. The network communication unit 25 realizes data communications with the data storage server 2, data management server 3, or terminal (PC) 4 via the network 5.

The image processor 26 applies various kinds of image processing to image data. The image processor 26 comprises an image processing circuit and the like. The image processor 26 executes image processing such as correction, compression/decompression, and the like of image data.

The user information acquisition unit 27 acquires user information such as user authentication data or the like. The user information acquisition unit 27 is implemented by, e.g., a card reader which reads information stored in an IC card possessed by the user. The user authentication data to be acquired by the user information acquisition unit 27 may use a password memorized by the user or user's living body information. For example, when the password memorized by the user is used as the user authentication information, the operation panel 12 from which the user inputs a password or the like is used as the user information acquisition unit 27 in place of the card reader 27. When user's living body information is used as the user authentication data, a living body information acquisition unit for acquiring living body information (for example, fingerprints, face image, iris, vein pattern, or the like) from the user is provided as the user information acquisition unit 27 in place of the card reader 27. Note that this embodiment reads user information including the user authentication information from the IC card possessed by the user.

The page memory 28 is a memory which has a storage area on which image data for at least one page is rendered. The page memory 28 is controlled by a page memory controller (not shown).

The HDD 29 is a large-capacity storage device. The HDD 29 is also used as a backup memory of various data, and stores various setting data or management data. The HDD 29 also stores data received via the network 5, image data scanned by the scanner unit 13, and the like as needed.

In the digital MFP 1 with the above arrangement, the CPU 21 implements various functions using the control programs and control data stored in the ROM 23, nonvolatile memory 24, or HDD 29.

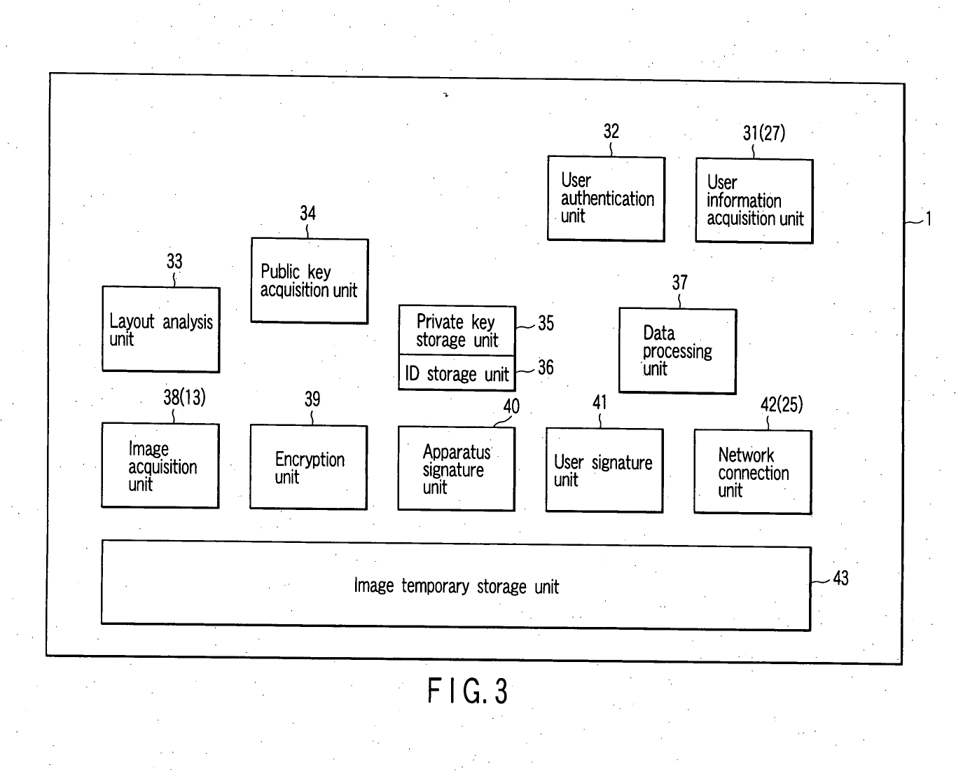

FIG. 3 is a block diagram showing an example of the functional arrangement of the image processing apparatus 1 for implementing the data processing system according to this embodiment.

As shown in FIG. 3, the image processing apparatus 1 has a user information acquisition unit 31, user authentication unit 32, layout analysis unit 33, public key acquisition unit 34, private key storage unit 35, ID storage unit 36, data processing unit 37, image acquisition unit 38, encryption unit 39, apparatus signature unit 40, user signature unit 41, network connection unit 42, image temporary storage unit 43, and the like.

The user information acquisition unit 31 acquires user information. For example, in the digital MFP shown in FIG. 2, the user information acquisition unit 31 is implemented by, e.g., the card reader 27. In this case, the card reader 27 serving as the user information acquisition unit 31 reads user authentication information as user information stored in an IC card presented by the user. Alternatively, the user information acquisition unit 31 may read a public key, private key, or the like of the user as the user authentication information.

The user authentication unit 32 executes user authentication processing on the basis of the user authentication information acquired by the user information acquisition unit 31. For example, in the digital MFP shown in FIG. 2, the user authentication unit 32 is implemented by the CPU 21 when it executes a user authentication program stored in the ROM 23, nonvolatile memory 24, or HDD 29. The user authentication unit 32 executes user authentication processing by collating the authentication data acquired by the user information acquisition unit 31, and authentication data (for example, authentication data stored in a storage device such as the HDD or the like or a server apparatus connected to the network 5) registered in advance.

The image acquisition unit 38 acquires image data. For example, in the digital MFP shown in FIG. 2, the image acquisition unit 38 is implemented by the scanner unit 13. Image data acquired by the image acquisition unit 38 is stored in the image temporary storage unit 43.

The layout analysis unit 33 extracts a region which satisfies a predetermined condition from image data. In this embodiment, the layout analysis unit 33 extracts a candidate of a region to be encrypted from image data. For example, the layout analysis unit 33 extracts a region of a significant graphic portion such as text, a logo, or the like in image data acquired by the image acquisition unit 38 as a candidate of an encryption region. In the digital MFP shown in FIG. 2, the layout analysis unit 33 is implemented by the CPU 21 when it executes a layout analysis program stored in the ROM 23, nonvolatile memory 24, or HDD 29.

The public key acquisition unit 34 acquires a public key of the user. The public key acquisition unit 34 acquires the public key of the user who has been successfully authenticated by the user authentication unit 32. In the digital MFP shown in FIG. 2, the public key acquisition unit 34 is implemented by the CPU 21 when it executes a public key acquisition program stored in the ROM 23, nonvolatile memory 24, or HDD 29.

For example, when the public key of the user is stored in the IC card possessed by the user, the public key acquisition unit 34 acquires the public key acquired by the user information acquisition unit 31. In the digital MFP shown in FIG. 2, the CPU 21 acquires the public key of the user read by the card reader 27 from the IC card presented by the user.

When the public key is stored in the storage device in the image processing apparatus 1, the public key acquisition unit 34 acquires the public key corresponding to the user who has been successfully authenticated by the user authentication unit 32 from the storage device in the image processing apparatus 1. In the digital MFP shown in FIG. 2, for example, the public key of each user is stored in the nonvolatile memory 24, HDD 29, or the like. In this case, in the digital MFP shown in FIG. 2, the CPU 21 acquires the public key corresponding to the user who has been successfully authenticated by the user authentication unit 32 from the nonvolatile memory 24 or HDD 29.

When the public key is stored in an external apparatus (e.g., the data management server 3) such as a server or the like connected to the network 5, the public key acquisition unit 34 acquires the public key corresponding to the user from the external apparatus via the network 5. In the digital MFP shown in FIG. 2, the CPU 21 acquires the public key corresponding to the user who has been successfully authenticated by the user authentication unit 32 from the NIC 25 via the network 5.

The private key storage unit 35 stores a private key of the image processing apparatus 1. For example, in the digital MFP shown in FIG. 2, the nonvolatile memory 24, HDD 29, or the like serves as the private key storage unit 35 which stores the private key of the digital MFP as the image processing apparatus 1. The private key storage unit 35 is protected by strong security. That is, the private key storage unit 35 is a memory area protected by the strong security.

The ID storage unit 36 stores ID information used to identify the image processing apparatus 1. In the digital MFP shown in FIG. 2, the nonvolatile memory 24, HDD 29, or the like serves as the ID storage unit 36 which stores the ID information of the digital MFP as the image processing apparatus 1. The ID storage unit 36 is protected by strong security. That is, the ID storage unit 36 is a memory area protected by the strong security.

The data processing unit 37 processes document data used to make various applications or reports. The data processing unit 37 has a function of acquiring a list of document data which are being edited by the user, a function of acquiring a list of templates of document data which can be used by the user, a function of executing processing for attaching image data to document data selected by the user, and the like. In the digital MFP shown in FIG. 2, the functions which implement the data processing unit 37 are implemented by the CPU 21 when it executes a data processing program stored in the ROM 23, nonvolatile memory 24, or HDD 29.

The encryption unit 39 executes encryption processing. The encryption unit 39 executes encryption processing of a designated region in image data. The encryption unit 39 encrypts image data using the user's public key by public-key cryptography. Note that an encryption scheme to be executed by the encryption unit 39 is not limited to the public-key cryptography. For example, the encryption scheme to be executed by the encryption unit 39 may use symmetric-key cryptography. In the digital MFP shown in FIG. 2, the encryption unit 39 is implemented by the CPU 21 when it executes an encryption processing program stored in the ROM 23, nonvolatile memory 24, or HDD 29.

The apparatus signature unit 40 appends a digital signature as the apparatus (apparatus signature) on data. This apparatus signature indicates that the data of interest is processed by the image processing apparatus 1. In this embodiment, the apparatus signature unit 40 appends an apparatus signature on document data using the private key of the image processing apparatus 1. In the digital MFP shown in FIG. 2, the apparatus signature unit 40 is implemented by the CPU 21 when it executes an apparatus signature program stored in the ROM 23, nonvolatile memory 24, or HDD 29.

The user signature unit 41 appends a digital signature as the user (user signature) on digital data. This user signature indicates that the data of interest belongs to the user who appended the signature. In this embodiment, the user signature unit 41 appends the user signature on document data. In the digital MFP shown in FIG. 2, the user signature unit 41 is implemented by the CPU 21 when it executes a user signature program stored in the ROM 23, nonvolatile memory 24, or HDD 29.

The network connection unit 42 makes data communications via the network 5. The network connection unit 42 transmits data such as document data and the like to the data storage server 2 and the like via the network 5. In the MFP shown in FIG. 2, the network connection unit 42 is implemented by the network communication unit 25.

The image temporary storage unit 43 is a storage area which temporarily stores data such as image data and the like required in various processes. On the image temporary storage unit 43, for example, processing for pasting image data to document data is executed. In the digital MFP shown in FIG. 2, the RAM 22, page memory 28, HDD 29, or the like is used as the image temporary storage unit 43.

A first processing example for attaching image data to document data by the image processing apparatus 1 will be described below.

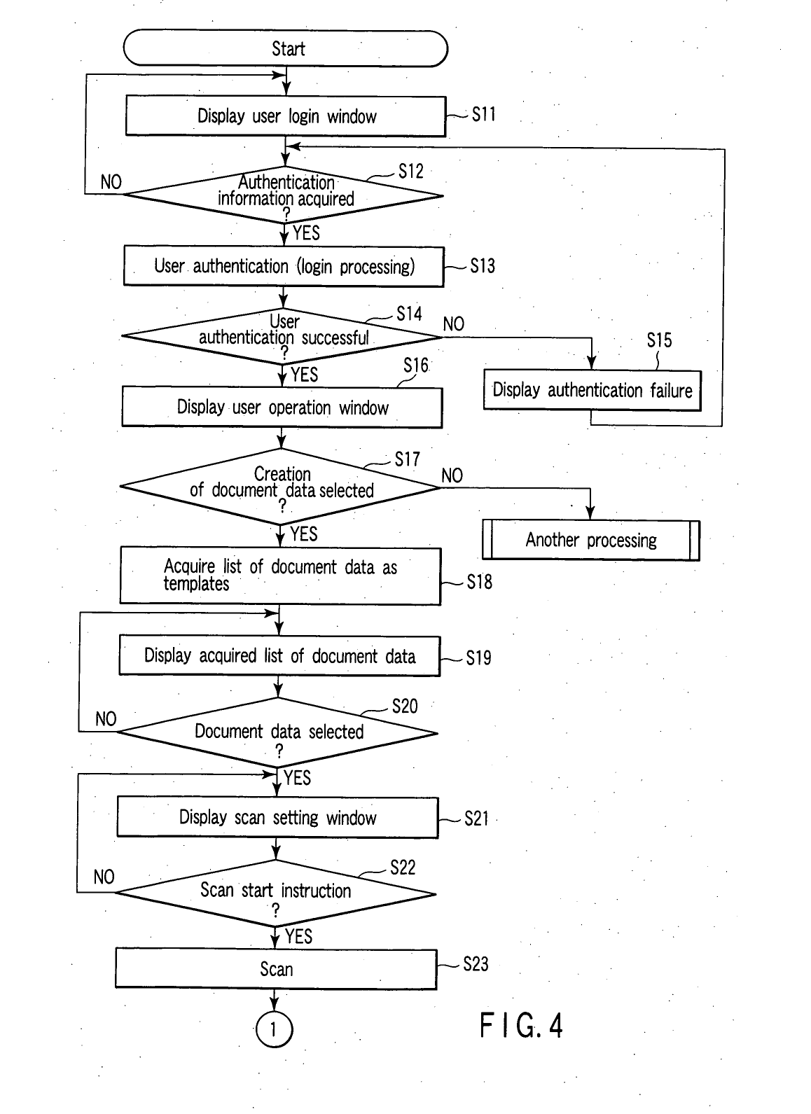

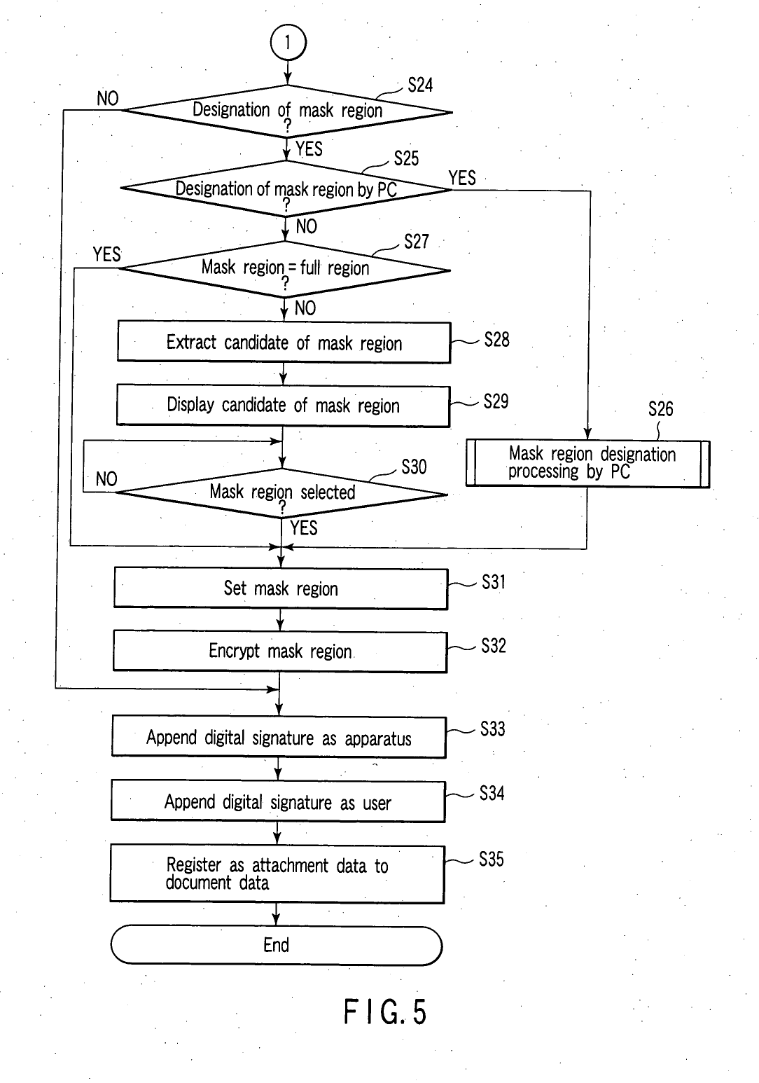

FIGS. 4 and 5 are flowcharts for explaining the first processing example of the digital MFP as the image processing apparatus 1.

In the first processing example, assume that document data which is edited by the user and to which image data is to be attached is saved in the data storage server 2. More specifically, the user creates (edits) document data on the terminal 4. The terminal 4 transfers the document data edited by the user to the data storage server 2 in accordance with a user operation. The data management server 3 stores (updates) management information of the document data saved in the data storage server 2. In this manner, the data management server 3 manages the document data saved in the data storage server 2 in correspondence with the user.

In such state, the image processing apparatus 1 executes processing for attaching image data to the document data edited by the user as the first processing example. The following description will be given under the assumption that the digital MFP shown in FIG. 2 as the image processing apparatus 1 executes the first processing example.

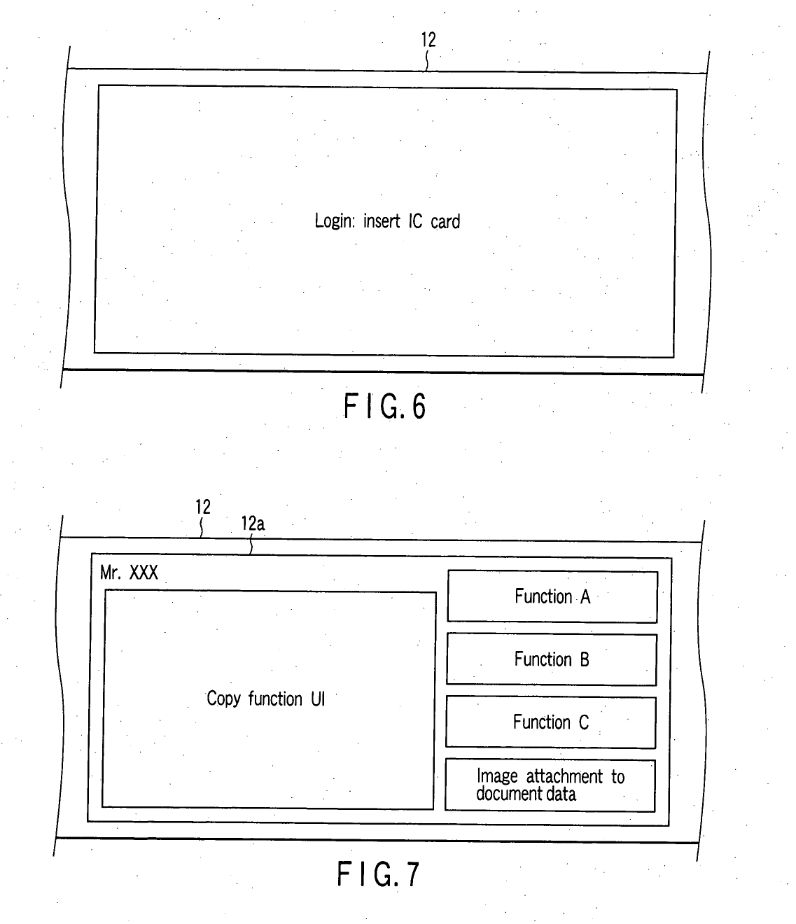

In the digital MFP as the image processing apparatus 1, a user login window is displayed on the operation panel 12 in a standby state (step S11). The user login window may be displayed in response to input to a predetermined operation key on the operation panel 12. FIG. 6 shows a display example of the user login window displayed on the display unit 12a of the operation panel 12. In the display example shown in FIG. 6, an insertion guide of an IC card which stores user information including user authentication data is displayed on the display unit 12a of the operation panel 12.

While the user login window is displayed, the user inputs authentication data of himself or herself. In this embodiment, the user presents the IC card which stores user information including authentication data to the card reader 27 as the user information acquisition unit. The card reader 27 then reads the user information including at least user authentication data from the IC card presented by the user (YES in step S12). After the card reader 27 reads the user information including user authentication data from the IC card (YES in step S12), the CPU 21 executes user authentication processing (login processing) on the basis of the user authentication data (step S13). This user authentication processing is done by collating the authentication data read from the IC card and that registered in advance in the HDD 29 or a database of an external apparatus or the like.

If the user authentication by the user authentication processing has failed, i.e., if the authentication data acquired from the IC card does not match the authentication data registered in advance (NO in step S14), the CPU 21 displays an authentication failure message on the display unit 12a of the operation panel 12 (step S15). In this case, the flow returns to step S12, and the CPU 21 acquires new authentication data presented by that user.

If the user authentication by the user authentication processing has succeeded, i.e., if the authentication data acquired from the IC card matches the authentication data registered in advance (YES in step S14), the CPU 21 loads setting information and the like corresponding to the user who has been successfully authenticated. The setting information of each user includes operation settings of that user, functions which can be used by the user, or the like. Assume that the setting information of each user is stored in the HDD 29, an external apparatus which can be connected via the network 5, or the like. After the setting information of the user who has been successfully authenticated is loaded, the CPU 21 displays an operation window for that user on the display unit 12a of the operation panel 12 on the basis of the setting information of the user (step S15). With these processes, the user login processing to the digital MFP is complete.

FIG. 7 shows a display example of the operation window for the user displayed on the display unit 12a of the operation panel 12. In the display example shown in FIG. 7, touch keys used to select basic functions (e.g., a copy function, scan function, printer function, or various setting functions) of the digital MFP are displayed, and a touch key used to select an image attachment function to document data is displayed. In response to a key selected by the user on such operation window, the CPU 21 executes various kinds of processing.

If the image attachment function to document data is selected on the aforementioned operation window (YES in step S17), the CPU 21 executes processing for generating image data to be attached to document data which is being edited by the user (the user who has been successfully authenticated, i.e., the login user). In this first processing example, assume that processing for attaching image data to document data which is being edited by the user who has been successfully authenticated is executed.

That is, if the image attachment function to document data is selected on the aforementioned operation window (YES in step S17), the CPU 21 acquires a list of document data (those to which image data can be appended) which are being edited by the login user (step S18). Assume that the document data which are being edited by the user are saved in the data storage server 2 and are managed by the data management server 3.

In this case, the CPU 21 requests the data management server 3 to output a list of document data which are being edited by the user. That is, the CPU 21 requests a list of document data which are being edited by the user who has been successfully authenticated by designating that user. In response to this request, the data management server 3 searches for all document data (those to which image data can be attached) which are being edited by the designated user, and returns a list of them to the digital MFP. Upon reception of the list from the data management server 3, the CPU 21 acquires the list of document data which are being edited by the login user.

After the list of document data which are being edited by the login user is acquired, the CPU 21 displays the acquired list of document data (a selection window of document data) on the display unit 12a of the operation panel 12 (step S19). The user can select document data displayed on the display unit 12a of the operation panel 12.

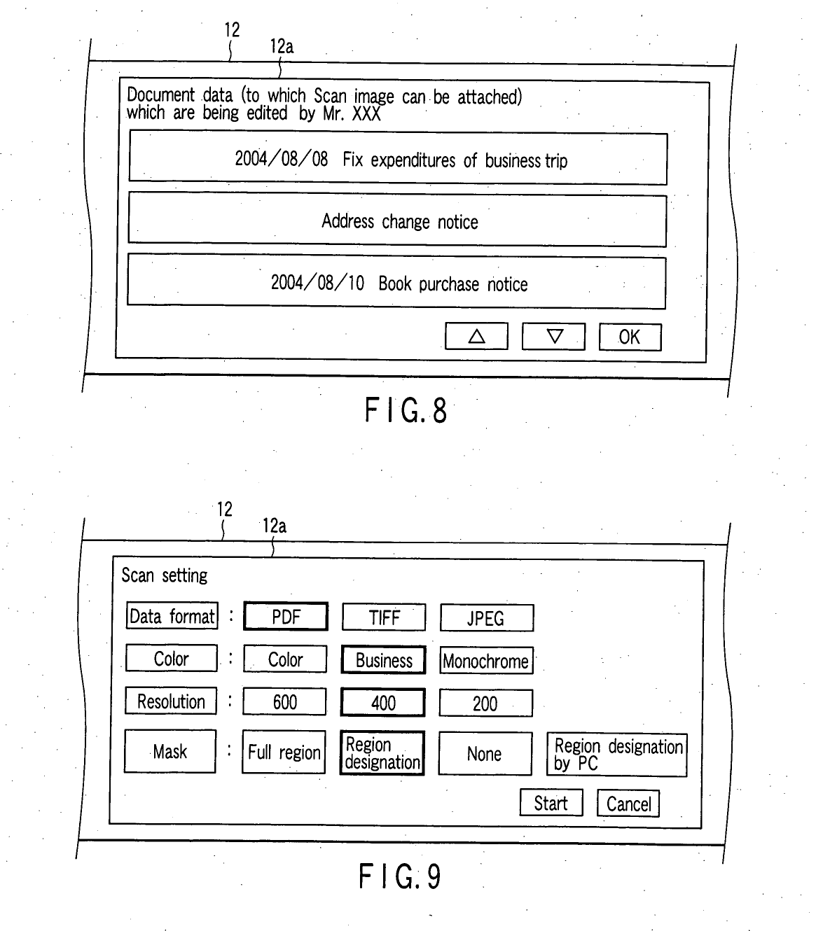

FIG. 8 shows a display example when the list of document data which are being edited by the login user (a selection window of document data) is displayed on the display unit 12a of the operation panel 12. In the display example of FIG. 8, a plurality of document data which are being edited by the login user are displayed to be selectable by the touch panel. In the display example shown in FIG. 8, “fix expenditures of business trip”, “address change notice”, and “book purchase notice” are selectably displayed as examples of document data which are being edited by the user. These are document data to which images of documents possessed by the user can be attached.

For example, “fix expenditures of business trip” is document data as an application form required to fix the expenditures upon a business trip. In this case, the user must attach images of documents such as receipts and the like indicating the amounts spent during the business trip to the document data “fix expenditures of business trip”. For this reason, upon selection of “fix expenditures of business trip”, the user sets, on the scanner unit 13, documents such as receipts and the like to be attached as image data to the document data “fix expenditures of business trip”.

On the other hand, “address change notice” is document data as an application form required to notify address change. In this case, the user must attach an image of a document indicating the address to be changed to the document data “address change notice”. For this reason, upon selection of “address change notice”, the user sets a document to be attached as image data to the document data “address change notice” on the scanner unit 13.

Also, “book purchase notice” is document data as an application form required to fix the purchase price of a book. In this case, the user must attach an image of a document such as a receipt or the like indicating the purchase price of a book to the document data “address change notice”. For this reason, upon selection of “address change notice”, the user sets a document such as a receipt to be attached as image data to the document data “address change notice” on the scanner unit 13.

If one document data is selected on the selection window of document data (YES in step S20), the CPU 21 executes setting processing for acquiring image data to be attached to the document data (steps S21 and S22). In this embodiment, assume that image data scanned by the scanner unit 13 (image data of a document presented by the user) is attached to the document data selected by the user. Therefore, if the user selects the document data, the CPU 21 displays a setting window for scanning an image of the document to be attached to the document data (scan setting window) on the display unit 12a of the operation panel 12 (step S21).

For example, FIG. 9 is a display example of the scan setting window displayed on the display unit 12a of the operation panel 12. In the display example shown in FIG. 9, a start key used to start a scan, a cancel key used to cancel a scan, touch keys used to select data formats of scanned image data, touch keys used to select color modes upon scanning a document (color modes of scanned image data), touch keys used to select resolutions upon scanning a document, touch keys used to set designation methods of a mask region for scanned image data, and the like are displayed.

Note that a mask region is a region to be encrypted on the scanned image data or the entire document data to which the scanned image data is attached. This embodiment assumes document data to be exchanged by a person who makes an application or report and that who accepts the application or report. For this reason, by encrypting the mask region designated by the user, the contents of the mask region are prevented from being read by a third party.

Furthermore, as the designation methods of the mask region, in the example shown in FIG. 9, a “full region” key, “region designation” key, “none” key, “designation by PC” key, and the like are selectable.

The “full region” key is used to designate, as a mask region, the entire scanned image data or the entire document data to which the scanned image data is attached. The “region designation” key is used to designate, as a mask region, a partial region of the scanned image data or the document data to which the scanned image data is attached. The “none” key is used to designate no mask region. The “designation by PC” key is used to designate a partial region of the scanned image data or the document data to which the scanned image data is attached by the terminal 4. Note that the processing upon designation of the “region designation” key and that upon designation of the “designation by PC” key will be described in detail later.

If such scan setting window is displayed, the user sets a document on the scanner unit 13, and sets the data format, color mode, resolution, and mask region designation method on the scan setting window. Upon completion of the setting of the document and designation of the setting contents, the user instructs to start a scan.

If the scan start instruction is input while the scan setting window is displayed (YES in step S22), the CPU 21 executes scan processing of a document image by the scanner unit 13 in accordance with the setting contents (step S23). The document image scanned by the scanner unit 13 is held as image data with the data format, color mode, and resolution designated on the scan setting window in the page memory 28 or HDD 29 as the image temporary storage unit 43.

Upon completion of the scan processing of the document image by the scanner unit 13 (after acquisition of image data to be attached to the document data), the CPU 21 checks the presence/absence of a mask region for the image data (step S24).

For example, if the user selects the “none” key as the mask region designation method on the scan setting window shown in FIG. 9, the CPU 21 determines that no mask region is set on the image data (NO in step S24). If it is determined that no mask region is designated for the image data acquired by the scanner unit 13, the CPU 21 skips the encryption processing, and the flow jumps to step S33 to be described later.

On the other hand, if the user selects a key other than “none” as the mask region designation method on the scan setting window shown in FIG. 9, the CPU 21 determines that a mask region is set on the scanned image data (YES in step S24). If a mask region is designated on the image data acquired by the scanner unit 13, the CPU 21 executes processing for setting a mask region based on the user's setting contents (steps S25 to S31).

For example, if the user selects the “designation by PC” key as the mask region designation method on the scan setting window shown in FIG. 9, the CPU 21 determines that a mask region on the image data is going to be designated using the terminal 4 (YES in step S25).

In this case, the CPU 21 saves the image data acquired by the scanner unit 13 in the HDD 29 in the digital MFP. After the image data acquired by the scanner unit 13 is saved in the HDD 29, the CPU 21 of the digital MFP temporarily suspends the processing for the image data until it is notified of the mask region designated by the user on the terminal 4.

In this state, the user designates a mask region for the image data saved in the HDD 29 of the digital MFP using the terminal 4. The terminal 4 accepts designation of a mask region for the image data saved in the HDD 29. When the user designates a mask region, the terminal 4 notifies the digital MFP of the mask region designated by the user. In response to the message indicating the mask region from the terminal 4, the digital MFP sets the mask region designated by the user on the terminal 4 as a region to be encrypted (step S31).

Note that the CPU 21 may register (save) the image data acquired by the scanner unit 13 in the data storage server 2 upon selection of “designation by PC”. In this case, the digital MFP may append a digital signature to the non-encrypted image data, and may register (save) the image data appended with the digital signature in the data storage server 2 in correspondence with the document data selected by the user. The processing for designating a mask region for image data registered (saved) in the data storage server 2 using the terminal 4 will be described in detail later.

If the user selects the “full region” key as the mask region designation method on the scan setting window shown in FIG. 9, the CPU 21 determines that the entire image data is set as a mask region (YES in step S27). In this case, the CPU 21 sets the entire image data as a mask region (step S31).

On the other hand, if the user selects the “region designation” key as the mask region designation method on the scan setting window shown in FIG. 9, the CPU 21 determines that a partial region selected by the user of the image data is set as a mask region (NO in step S27). In this case, the CPU 21 executes processing for prompting the user to designate a mask region on the digital MFP (steps S28 to S30).

More specifically, if it is determined that the user designates a mask region (NO in step S27), the CPU 21 executes layout analysis processing for analyzing the layout of the image data acquired by the scanner unit 13 (step S28). Note that this layout analysis processing is executed by the layout analysis unit 33 in the example of the arrangement shown in FIG. 3.

The layout analysis processing extracts a candidate of a mask region from the image data. That is, the layout analysis processing extracts a region, which satisfies a predetermined condition set in advance, on the image data as a candidate of a mask region. For example, as the condition for extracting a candidate of a mask region, a condition for extracting a text region or graphic region is set. In this case, the layout analysis processing sets all text regions or graphic regions extracted from the image data as candidates of a mask region.

After the candidates of the mask region are extracted by the layout analysis processing, the CPU 21 selectably displays the extracted candidates of the mask region on the display unit 12a of the operation panel 12 (step S29). On a display window for selecting the mask region (region selection window), the CPU 21 prompts the user to designate a region to be encrypted from the candidates of the mask region obtained by the layout analysis processing.

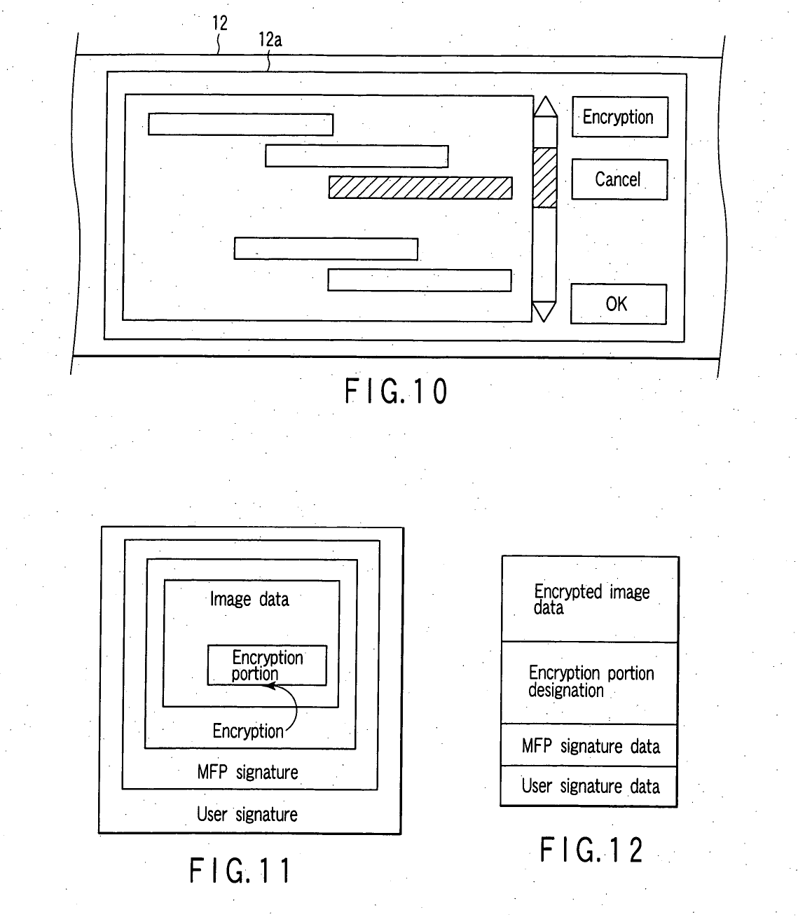

For example, FIG. 10 shows a display example of the mask region selection window. In the display example shown in FIG. 10, all the candidates of the mask region extracted from the image data are selectably displayed. In the example shown in FIG. 10, the candidates of the mask region extracted by the layout analysis processing are displayed together with the image data to be selectable by the touch panel.

While the mask region selection window is displayed on the display unit 12a of the operation panel 12, the user selects the mask region to be encrypted. After the user selects the mask region to be encrypted (YES in step S30), the CPU 21 sets the selected mask region as a region to be encrypted (step S31).

After the region to be encrypted (mask region) is set in step S31, the CPU 21 executes encryption processing for encrypting a region set as the region to be encrypted on the image data (step S32). Note that this encryption processing is executed by the encryption unit 39 in the example of the arrangement shown in FIG. 3. More specifically, as described above, in the encryption processing, for example, the image data is encrypted using the user's public key by the public-key cryptography. Note that the encryption processing may be executed by symmetric-key cryptography. The public key of the user (login user) is acquired by the public key acquisition processing. This public key acquisition processing is executed by the public key acquisition unit 34 in the example of the arrangement shown in FIG. 3.

After the region designated by the user is encrypted, the CPU 21 appends a digital signature as the apparatus (apparatus signature) to the encrypted image data (step S33). Note that the apparatus signature processing is executed by the apparatus signature unit 40 in the example of the arrangement shown in FIG. 3. More specifically, as described above, the apparatus signature processing appends a digital signature as the apparatus to the image data (encrypted image data) using the private key and ID information of the digital MFP, and the like. This apparatus signature can guarantee that the image data is processed by the digital MFP. The private key and ID information of the digital MFP are stored in the nonvolatile memory 24, HDD 29, or the like as the private key storage unit 35 and ID storage unit 36.

After the apparatus signature as the digital MFP is appended to the image data, the CPU 21 further appends a digital signal as the user (user signature) to the image data (encrypted image data appended with the apparatus signature) (step S34). Note that this user signature processing is executed by the user signature unit 41 in the example of the arrangement shown in FIG. 3. More specifically, as described above, the user signature processing appends a digital signature as the user (login user) to the image data (encrypted image data appended with the apparatus signature). This user signature can guarantee that the image data is processed based on designation of the user.

With the processes in steps S32 to S34, the encryption, apparatus signature, and user signature processes are applied to the image data acquired by the scanner unit 13. The image data which has undergone the encryption, apparatus signature, and user signature processes is data whose designated portion (encryption region) is encrypted and for which the apparatus and user are guaranteed.

FIG. 11 shows a logical data structure of the image data which has undergone the encryption, apparatus signature, and user signature processes. FIG. 12 shows a physical data structure of the image data which has undergone the encryption, apparatus signature, and user signature processes. More specifically, the image data which has undergone the encryption, apparatus signature, and user signature processes logically has a state wherein a portion of the image data is encrypted, the apparatus signature is appended to the partially encrypted image data, and the user signature is appended to the data appended with the apparatus signature, as shown in FIG. 11. The image data which has undergone the encryption, apparatus signature, and user signature processes physically has a configuration in which information indicating the encrypted region, apparatus signature data as the apparatus signature, and user signature data as the user signature are given to the image data including the encrypted region, as shown in FIG. 12.

Upon completion of the encryption, apparatus signature, and user signature processes, the CPU 21 executes registration processing for registering the image data as attachment data of the document data selected by the user (step S35). This registration processing registers the image data which has undergone the encryption, apparatus signature, and user signature processes as attachment data of the document data selected by the user. More specifically, in this data processing system, the digital MFP transmits, to the data storage server 2, the image data which has undergone the encryption, apparatus signature, and user signature processes as attachment data of the document data selected by the user in the registration processing. Then, the data storage server 2 attaches the data received from the digital MFP (the image data which has undergone the encryption, apparatus signature, and user signature processes) to the document data selected by the user. In this way, the image data acquired by the scanner unit 13 is attached to the document data selected by the user.

As described above, in the first processing example, the digital MFP as the image processing apparatus executes processing for authenticating the user, acquiring a list of document data which are being edited by the user whose authentication by the user authentication has succeeded, acquiring an image to be appended to the document data selected by the user from the acquired list, and attaching the acquired image data to the document data selected by the user.

As described above, in the first processing example, image data as an image of a document can be easily attached to document data edited by the user.

In the first processing example, the user selects document data to which an image is to be attached from the list of document data which are being edited by the user whose authentication by the user authentication has succeeded. For this reason, according to the first processing example, the user can easily select the document data to which an image is to be attached and is being edited.

Image data to be attached to the document data undergoes encryption processing and digital signature processing. In this manner, the security of the image data to be attached to the document data can be guaranteed.

A second processing example for attaching image data to document data by the image processing apparatus 1 will be described below.

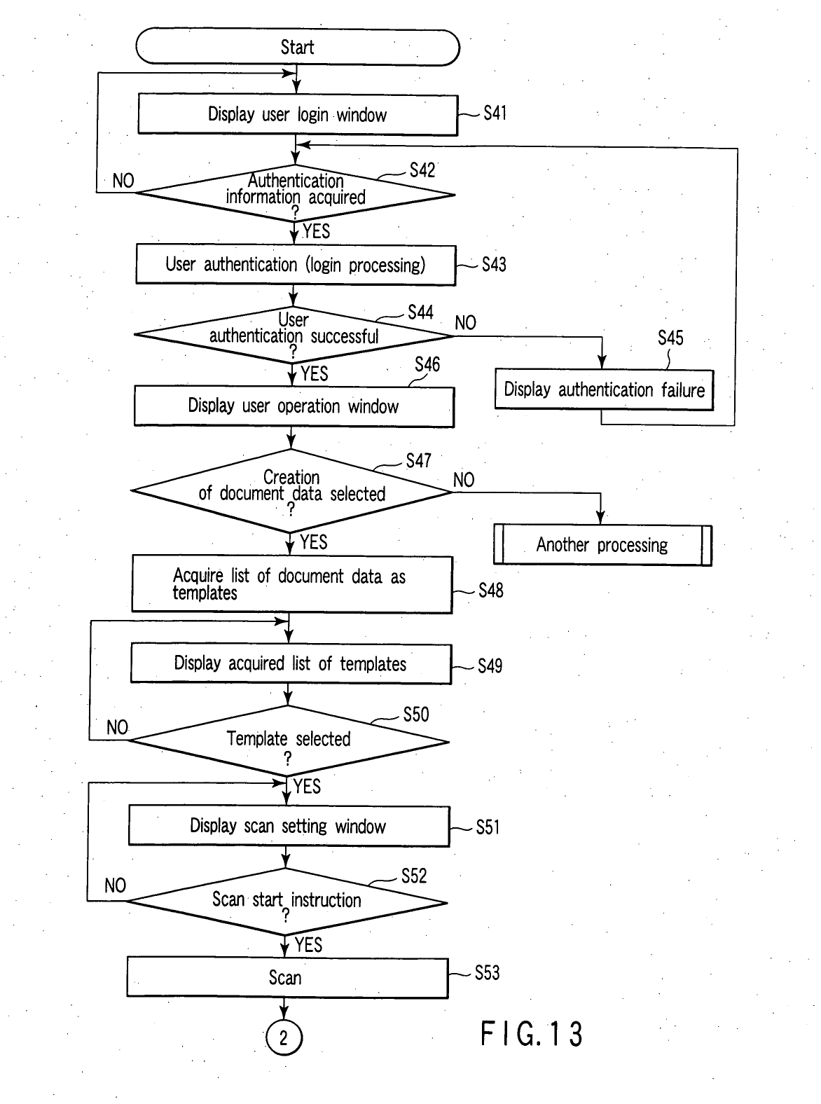

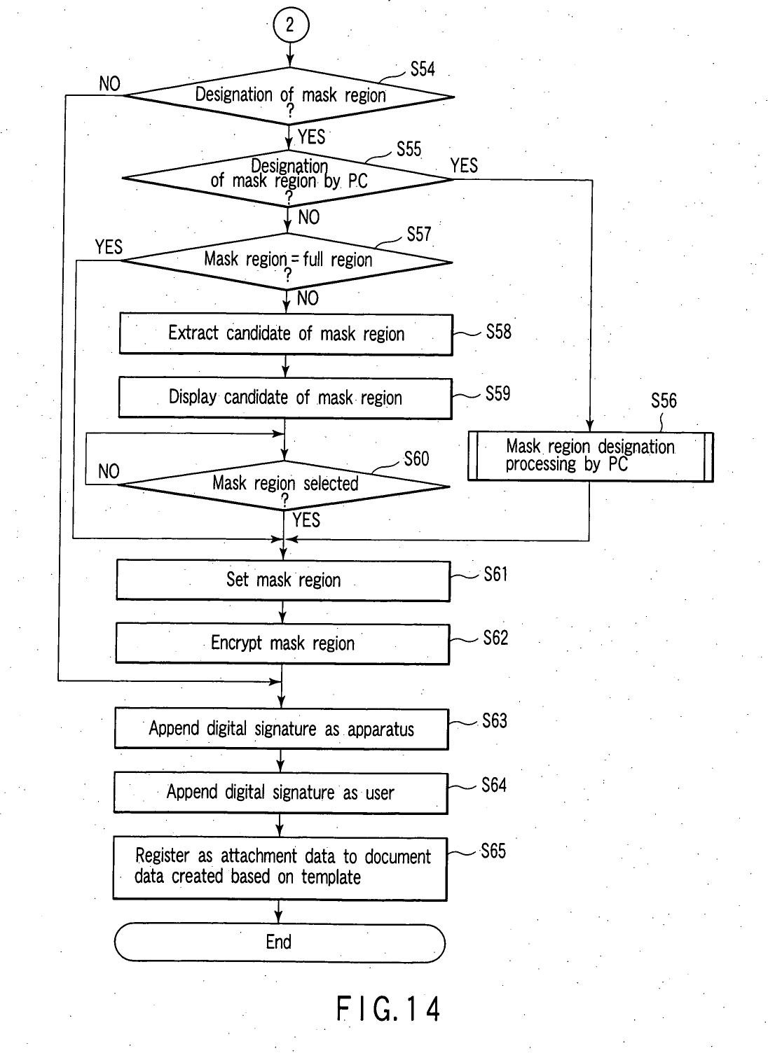

FIGS. 13 and 14 are flowcharts for explaining the second processing example by the digital MFP as the image processing apparatus 1.

In the second processing example, assume that the image processing apparatus 1 or data storage server 2 saves templates used as document data. The data management server 3 manages a list of templates that can be used by each user of the aforementioned templates. Note that the data management server 3 manages templates which can be used according to the authority of the user.

In this state, the image processing apparatus 1 executes processing for attaching image data to document data to be newly created on the basis of a template selected by the user as the second processing example. The following explanation will be given under the assumption that the digital MFP shown in FIG. 2 as the image processing apparatus 1 executes the second processing example.

The digital MFP as the image processing apparatus 1 executes user login processing (authentication processing) (steps S41 to S46). The processes in steps S41 to S46 are the same as those in steps S11 to S16.

That is, the display unit 12a of the operation panel 12 of the digital MFP displays the user login window in a standby state (step S41). In this state, the user information acquisition unit 27 acquires user authentication data. In this embodiment, the card reader as the user information acquisition unit 27 acquires user information including user authentication data from an IC card possessed by the user.

If the user authentication data is acquired (YES in step S42), the CPU 21 executes user authentication processing based on the user authentication data (step S43). If the user authentication by the user authentication processing has failed (NO in step S44), the CPU 21 displays an authentication failure message on the display unit 12a of the operation panel 12 (step S45).

If the user authentication by the user authentication processing has succeeded (YES in step S44), the CPU 21 displays an operation window for that user (for example, the operation window shown in FIG. 7) on the display unit 12a of the operation panel 12 on the basis of setting information of the user whose authentication has succeeded (step S46). In response to a key selected by the user on such operation window, the CPU 21 executes various kinds of processing.

If the image attachment function to document data is selected on the aforementioned operation window (YES in step S47), the CPU 21 executes processing for generating image data to be attached to document data (new document data to be created) selected from a template by the user (the user who has been successfully authenticated, i.e., the login user). The second processing example executes processing for creating new document data from a template, and attaching image data to the newly created document data.

More specifically, if the image attachment function to document data is instructed on the aforementioned operation window (YES in step S47), the CPU 21 acquires a list of template (document data to which image data can be attached) as document data which can be used by the login user (step S48). Assume that the templates of document data to which image data can be attached are saved in the data storage server 2. Also, a list of templates which can be used by each user is managed by the data management server 3.

In this case, the CPU 21 requests the data management server 3 to output a list of templates as document data which can be used by the user. That is, the CPU 21 requests a list of templates as document data which can be used by the user whose authentication has succeeded by designating that user. In response to this request, the data management server 3 searches for all templates of document data (those to which image data can be attached) which can be used by the designated user, and returns a list of them to the digital MFP. Upon reception of the list from the data management server 3, the CPU 21 acquires the list of templates of document data which can be used by the login user.

After the list of templates as document data which can be used by the login user is acquired, the CPU 21 displays the acquired list of templates (a selection window of document data) on the display unit 12a of the operation panel 12 (step S49). The user can select templates displayed on the display unit 12a of the operation panel 12 as new document data to be created.

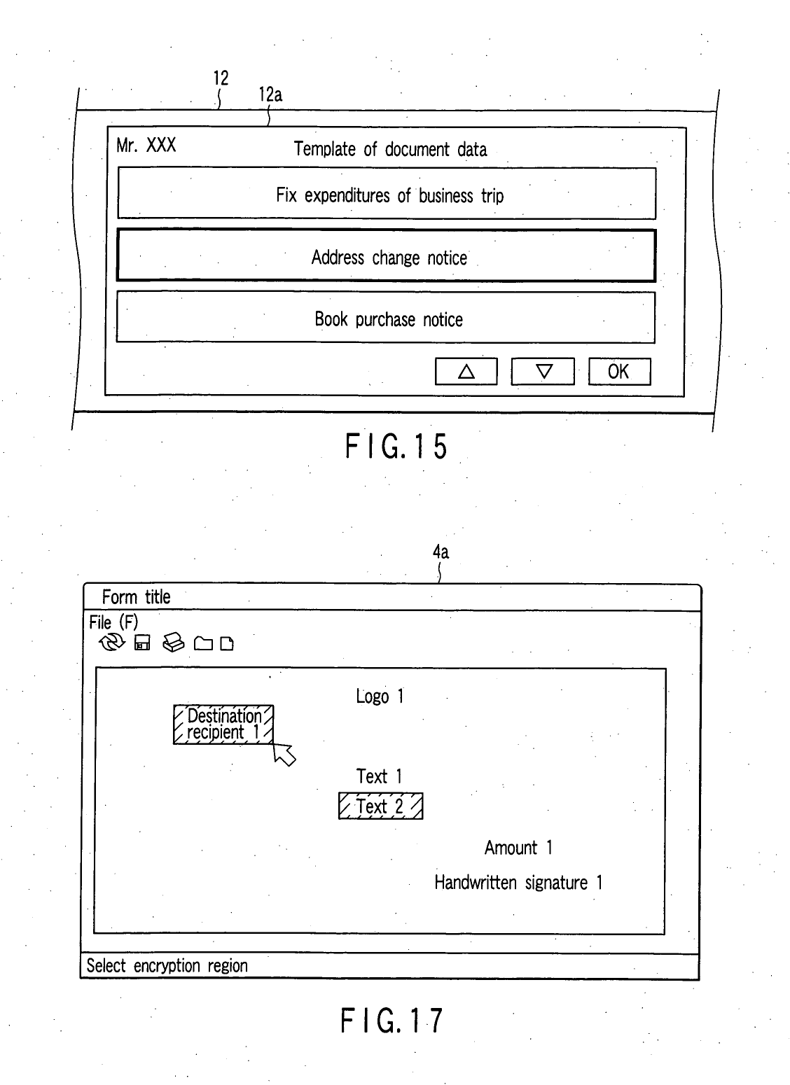

FIG. 15 shows a display example when the list of templates as document data which can be used by the login user (a selection window of templates) is displayed on the display unit 12a of the operation panel 12. In the display example of FIG. 15, a plurality of templates (new document data to be created) which can be used by the login user are displayed to be selectable by the touch panel. In the display example shown in FIG. 15, “fix expenditures of business trip”, “address change notice”, and “book purchase notice” are selectably displayed as examples of document data which can be used by the user. These are templates as document data to which images of documents possessed by the user can be attached.

For example, “fix expenditures of business trip” is a template of document data as an application form required to fix the expenditures upon a business trip. In this case, the user sets, on the scanner unit 13, documents such as receipts and the like to be attached as image data to new document data “fix expenditures of business trip” to be created. On the other hand, “address change notice” is a template of document data as an application form required to notify address change. In this case, the user sets a document to be attached as image data to new document data “address change notice” to be created on the scanner unit 13. Also, “book purchase notice” is document data as an application form required to fix the purchase price of a book. In this case, the user sets a document such as a receipt to be attached as image data to new document data “address change notice” to be created on the scanner unit 13.

If a template of one document data is selected on the selection window of document data (YES in step S50), the CPU 21 executes setting processing for acquiring image data to be attached to the document data (steps S51 and S52). This setting processing is the same as the processes in steps S21 and S22.

That is, if the user selects a template as one document data, the CPU 21 displays a setting window for scanning an image of the document to be attached to the document data (for example, the scan setting window shown in FIG. 9) on the display unit 12a of the operation panel 12 (step S51).

If such scan setting window is displayed, the user sets a document on the scanner unit 13, and sets the data format, color mode, resolution, and mask region designation method on the scan setting window. Upon completion of the setting of the document and designation of the setting contents, the user instructs to start a scan.

If the scan start instruction is input (YES in step S52), the CPU 21 executes scan processing of a document image by the scanner unit 13 in accordance with the setting contents (step S53) as in step S23 above. Upon completion of the scan processing of the document image by the scanner unit 13 (after acquisition of image data to be attached to new document data to be created), the CPU 21 executes setting processing and encryption processing of a mask region according to the user's designation (steps S54 to S62).

For example, if the user designates a mask region=“none” (NO in step S54), the CPU 21 skips the encryption processing, and the flow jumps to step S63 to be described later.

On the other hand, if the user selects “designation by PC” as the mask region designation method (YES in step S55), the CPU 21 saves the image data in the HDD 29 in the digital MFP.

After the image data acquired by the scanner unit 13 is saved in the HDD 29, the CPU 21 of the digital MFP temporarily suspends the processing for the image data until it is notified of the mask region designated by the user on the terminal 4.

In this state, the user designates a mask region for the image data saved in the HDD 29 of the digital MFP using the terminal 4. The terminal 4 displays the image data saved in the HDD 29 on the display unit 4a.

In this state, the terminal 4 accepts designation of a mask region for the image data saved in the HDD 29 by the user. When the user designates a mask region, the terminal 4 notifies the digital MFP of the mask region designated by the user. In response to the message indicating the mask region from the terminal 4, the digital MFP executes (restarts) processes in step S61 and subsequent steps.

Note that the CPU 21 may register (save) the image data acquired by the scanner unit 13 in the data storage server 2 upon selection of “designation by PC”. In this case, the digital MFP may append a digital signature to the non-encrypted image data, and may register (save) the image data appended with the digital signature in the data storage server 2 in correspondence with the document data selected by the user. The processing for designating a mask region for image data registered (saved) in the data storage server 2 using the terminal 4 will be described in detail later.

If the user selects “full region” as a mask region, the CPU 21 sets the entire image data as a mask region (step S61).

On the other hand, if the user selects “region designation” as the mask region designation method, the CPU 21 executes processing for prompting the user to designate a mask region on the digital MFP (steps S58 to S60). Since the processes in steps S58 to S60 are the same as those in steps S28 to S30, a detailed description thereof will be omitted.

After the user selects the mask region to be encrypted (YES in step S60), the CPU 21 sets the selected mask region as a region to be encrypted (step S61).

After the region to be encrypted (mask region) is set in step S61, the CPU 21 executes encryption processing of the region set on the image data, apparatus signature processing, and user signature processing based on the user's designation (steps S62 to S64). Since the processes in steps S62 to S64 are the same as those in steps S32 to S34, a detailed description thereof will be omitted.

Upon completion of the encryption, apparatus signature, and user signature processes in steps S62 to S64, the CPU 21 executes registration processing for registering the image data as attachment data of the new document data based on the template selected by the user (step S65).

In this registration processing, for example, the CPU 21 creates new document data based on the template selected by the user. The CPU 21 sets image data that has undergone the encryption, apparatus signature, and user signature processes as attachment data of the newly created document data. Furthermore, the CPU 21 transmits the document data having the image data as attachment data to the data storage server 2. Then, the data storage server 2 registers the document data attached with the image data, which is received from the digital MFP, as the document data of the user.

In the registration processing, the new document data based on the template selected by the user may be created by the data storage server 2. In this case, the CPU 21 of the digital MFP transmits information indicating the template selected by the user, and image data that has undergone the encryption, apparatus signature, and user signature processes to the data storage server 2. Then, the data storage server 2 creates new document data based on the template selected by the user, and registers the image data that has undergone the encryption, apparatus signature, and user signature processes as attachment data of the newly created document data.

As described above, in the second processing example, the digital MFP as the image processing apparatus executes processing for authenticating the user, acquiring a list of templates of document data which can be used by the user whose authentication by the user authentication has succeeded, acquiring an image to be appended to new document data to be created based on the template selected by the user from the acquired list, and attaching the acquired image data to the newly created document data based on the template selected by the user.

In this way, according to the second processing example, image data as an image of a document can be easily attached to new document data created based on the template selected by the user.

In the second processing example, the user selects new document data to which an image is to be attached from the list of templates of document data which can be used by the user whose authentication by the user authentication has succeeded. For this reason, according to the second processing example, the user can easily select new document data to which an image is to be attached from templates.

Image data to be attached to the document data undergoes encryption and digital signature processes. In this manner, the security of the image data to be attached to the document data can be guaranteed.

The designation processing of a mask region (encryption region) by the terminal (PC) 4 will be described below.

In the first and second processing examples, the encryption region in image data to be attached to document data can be designated by the PC, as described above.

Also, as described above, in the mask region designation processing by the terminal 4, the user designates a mask region in image data at the terminal 4. The terminal 4 notifies the image processing apparatus 1 of information indicating the mask region designated on the terminal 4. The image processing apparatus 1 encrypts the mask region notified by the terminal 4.

In this case, if non-encrypted image data (image data for which the PC designates a mask region) is saved in the storage device such as the HDD or the like in the image processing apparatus, the terminal 4 can acquire the image data from the image processing apparatus 1, and can notify information indicating a mask region in that image data.

However, in the image processing apparatus 1 as the digital MFP or the like, the capacity of the storage device such as the HDD or the like is limited. Also, in the image processing apparatus 1 as the digital MFP or the like, the processing performance is limited. For these reasons, it is often preferable to save non-encrypted image data in an apparatus outside the image processing apparatus 1, e.g., in the data storage server 2 or the like.

Processing executed when image data acquired by the image processing apparatus 1 is saved in the data storage server 2, and the terminal 4 designates a mask region on the image data saved in the data storage server 2 will be described below.

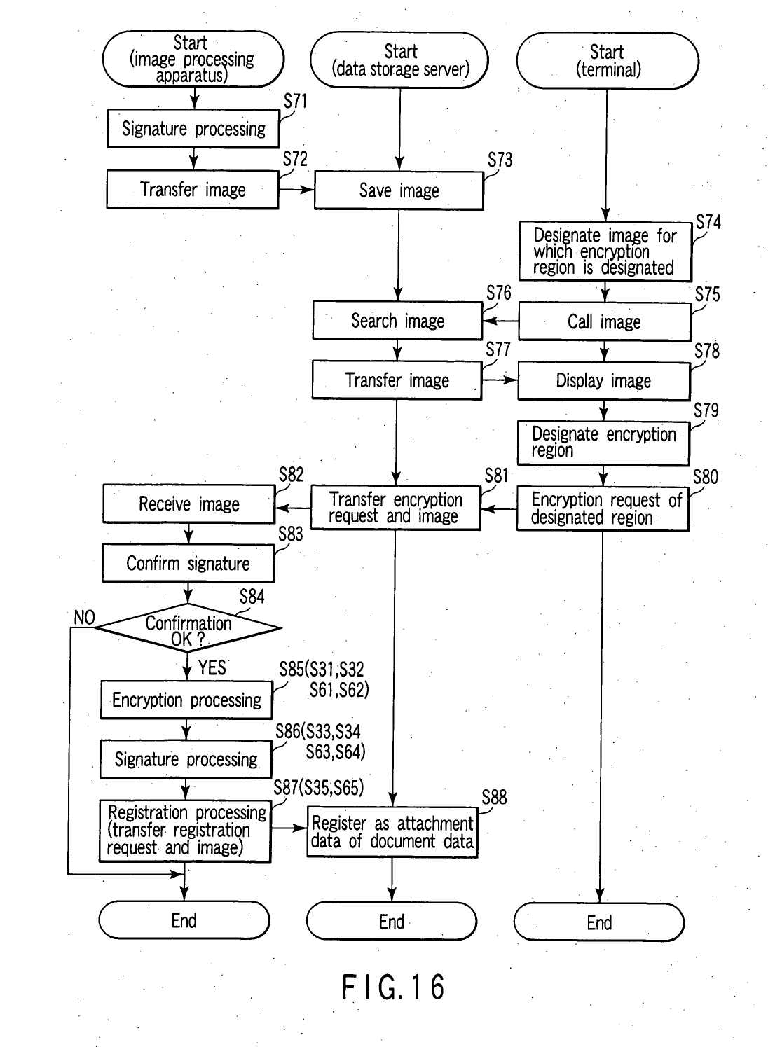

FIG. 16 is a flowchart for explaining the processing executed when the terminal 4 designates a mask region in image data saved in the data storage server 2.

If “designation by PC” is designated, the CPU 21 of the digital MFP as the image processing apparatus appends a digital signature to image data scanned by the scanner unit 13 (step S71). Note that at least an apparatus signal may be appended as the digital signature. Alternatively, apparatus and user signatures may be appended as the digital signature.

After the digital signature is appended to the image data acquired by the scanner unit 13, the CPU 21 transfers the image data appended with the digital signature to the data storage server 2 (step S72). In this case, assume that the image data appended with the digital signature is transferred in correspondence with the document data selected by the user.

Upon reception of the image data appended with the digital signature from the digital MFP, the data storage server 2 saves the image data appended with the digital signature in correspondence with the document data (step S73).

On the other hand, when the digital MFP scans an image of a document to be attached to the document data, the user makes an operation for designating a region to be encrypted on the image at the terminal 4. The user instructs to launch an application program used to designate a region to be encrypted from the operation unit 4b of the terminal 4. The processing unit 4c of the terminal 4 launches the application program in response to the user's instruction.

After the application program used to designate an encryption region is launched, the user designates image data for which the encryption region is to be designated using the operation unit 4b (step S74). In this case, for example, the user inputs information for identifying image data. Alternatively, the user may select desired image data from a list of image data for that user, which is acquired by the terminal 4 from the data storage server 2.

Upon designation of the image data for which the encryption region is to be designated, the processing unit 4c of the terminal 4 requests the data storage server 2 to send the image data (step S75).

In response to this request, the data storage server 2 searches for image data designated by the terminal 4 (step S76). If the image data designated by the terminal 4 is found, the data storage server 2 transfers that image data to the terminal 4 (step S77).

Upon reception of the image data as an object for which a mask region is to be designated from the data storage server 2, the processing unit 4c of the terminal 4 displays the received image data, and also displays a guidance for prompting the user to designate an encryption region on the image data (encryption region designation window) on the display unit 4a (step S78). In this state, the terminal 4 accepts designation of an encryption region. That is, the user designates a region to be encrypted using the operation unit 4b while a desired image is displayed on the display unit 4a (step S79).

For example, FIG. 17 shows a display example of the encryption region designation window displayed on the display unit 4a of the terminal 4. In the display example shown in FIG. 17, image data as an object for which a mask region is to be designated is displayed. On the designation window shown in FIG. 17, the user designates an encryption region in that image using a mouse or the like as the operation unit 4b. The display example shown in FIG. 17 shows a state wherein two regions, i.e., a region “destination recipient 1” and region “text 2”, are designated as encryption regions.

After the user designates the encryption region (or regions) on the image data, the processing unit 4c of the terminal 4 requests the digital MFP to encrypt the designated region on the image data via the data storage server 2 (step S80). In this processing for requesting encryption, the processing unit 4c of the terminal 4 transmits information indicating the designated region to the data storage server together with an encryption request. The data storage server 2 transfers the image data to the digital MFP together with the information indicating the region to be encrypted from the terminal 4 (step S81).

Upon reception of the information indicating the encryption region and image data, the CPU 21 of the digital MFP confirms the digital signature appended to the image data (step S82). In this case, the CPU 21 confirms if the appended digital signature is its own digital signature. If it is determined in this confirmation that the appended digital signature is not its own digital signature (NO in step S83), the CPU 21 ends the processing as an error.

If it is confirmed that the image data requested to be encrypted is data appended with its own digital signature (YES in step S83), the CPU 21 of the digital MFP applies the encryption processing to the image data (step S85) as in steps S31 and S32 or steps S61 and S62. After the encryption processing is applied to the image data, the CPU 21 of the digital MFP appends an apparatus signature and user signature as digital signatures to the encrypted image data (step S86) as in steps S33 and S34 or steps S63 and S64.

When the image data has undergone the encryption processing, the signature data appended to that image data is discarded. For this reason, the CPU 21 applies the digital signature processing to the encrypted image data again. As a result, the apparatus and user can be guaranteed for the encrypted image data.

After the encryption and digital signature processes are applied to the image data, the CPU 21 executes processing for registering the encrypted image data appended with the digital signature in the data storage server 2 as attachment data of the document data (step S87) as in step S35 or S65.

In this registration processing, the CPU 21 transmits the image data, in which the region designated by the terminal 4 is encrypted and to which the digital signature is appended, to the data storage server 2. As a result, the data storage server 2 registers the image data, in which the region designated by the terminal 4 is encrypted and to which the digital signature is appended, as attachment data of the document data associated with that image data (step S88).

In the aforementioned encryption region designation processing by the terminal 4, image data before encryption is saved in the data storage server 2, and information of an encryption region designated by the user on the terminal 4 and the image data are transmitted to the image processing apparatus. The image processing apparatus encrypts the encryption region designated by the terminal 4, and registers it as attachment data of document data.

In this way, the encryption region can be designated at the terminal irrespective of the resources of the storage device in the image processing apparatus.

Furthermore, the image processing apparatus appends a digital signature to image data before encryption, and saves it in the data storage server 2. When the user designates an encryption region at the terminal 4, the terminal 4 transmits the image data appended with the digital signature and information indicating the encryption region to the image processing apparatus via the data storage server 2. The image processing apparatus confirms the digital signature of the received image data. When it is confirmed that the digital signature of the image data is authentic, the image processing apparatus encrypts the encryption region notified by the terminal, appends a digital signature to the encrypted image data again, and registers the image data appended with the digital signature as attachment data of the document data.

In this way, the encryption region can be designated at the terminal irrespective of the resources of the storage device in the image processing apparatus, and falsification of image data and the like during these processes can be prevented.

As described above, in this embodiment, user authentication is made, and the user whose authentication has succeeded selects document data to which an image is to be attached. While the user selects the document data, an image of a document is scanned, and the scanned image is attached to the document data selected by the user. As a result, an image of a document that uses a paper sheet as a master copy can be easily attached as image data to document data such as an application form, report, and the like.

In this embodiment, a list of document data which are being edited by the user whose authentication has succeeded (or templates of document data which can be used by that user) is displayed, and the user selects document data to which an image is to be attached from the displayed list. As a result, according to this embodiment, document data to which an image is to be attached can be easily selected.

In this embodiment, a digital signature such as an apparatus signature, user signature, or the like is appended to image data to be attached to document data. In this manner, according to this embodiment, falsification of image data to be attached to document data can be prevented. Also, according to this embodiment, the apparatus which acquires the image data attached to the document data, the date and time when the image data attached to the document data is acquired, the user who attaches the image data to the document data, or the like can be guaranteed.

Furthermore, in this embodiment, a region designated by the user on the image data to be attached to the document data is encrypted. In this way, according to this embodiment, the contents of the region designated by the user can be prevented from being accessed by a person who does not have any decryption means. In other words, according to this embodiment, the region designated by the user on the image data attached to the document data can only be accessed by only a person who has predetermined authority.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a user authentication unit which authenticates a user;
a list acquisition unit which acquires a list of document data which are configured to be selected by the user whose authentication by the user authentication unit has succeeded;
an image acquisition unit which acquires, when one document data is selected from the list of document data acquired by the list acquisition unit, image data to be attached to the selected document data; and
a registration unit which registers the image data acquired by the image acquisition unit as attachment data of the selected document data.

2. An apparatus according to claim 1, wherein the list acquisition unit acquires the list of document data which are configured to be attached with image data of document data which are edited by the user whose authentication by the user authentication unit has succeeded and are stored in a specific storage device, and
the registration unit registers the image data acquired by the image acquisition unit as attachment data of the selected document data.

3. An apparatus according to claim 1, wherein the list acquisition unit acquires a list of templates as document data which are configured to be used by the user whose authentication by the user authentication unit has succeeded, and
the registration unit registers the image data acquired by the image acquisition unit as attachment data of document data based on the selected template.

4. An apparatus according to claim 1, which further comprises a signature unit which appends a digital signature to the image data acquired by the image acquisition unit,
in which the registration unit registers the image data appended with the digital signature by the signature unit as attachment data of the selected document data.

5. An apparatus according to claim 4, wherein the signature unit includes an apparatus signature unit which guarantees that the image processing apparatus processes, and a user signature unit which guarantees the user who is authenticated by the user authentication unit.

6. An apparatus according to claim 1, which further comprises an encryption unit which encrypts at least a partial region on the image data acquired by the image acquisition unit,
in which the registration unit registers the image data encrypted by the encryption unit as attachment data of the selected document data.

7. An apparatus according to claim 6, which further comprises a layout analysis unit which extracts candidates of regions to be encrypted on the image data acquired by the image acquisition unit,
in which the encryption unit encrypts a region designated from the candidates of regions extracted by the layout analysis unit on the image data acquired by the image acquisition unit.

8. An image processing system having an image processing apparatus and a terminal which is configured to communicate with the image processing apparatus,
the image processing apparatus comprising:
a user authentication unit which authenticates a user;
a list acquisition unit which acquires a list of document data which are configured to be selected by the user whose authentication by the user authentication unit has succeeded;
an image acquisition unit which acquires, when one document data is selected from the list of document data acquired by the list acquisition unit, image data to be attached to the selected document data;
an encryption unit which encrypts a region to be encrypted notified by the terminal on the image data acquired by the image acquisition unit; and
a registration unit which registers the image data encrypted by the encryption unit as attachment data of the selected document data, and
the terminal comprising:
an operation unit to accept designation of a region to be encrypted on the image data which is acquired by the image processing apparatus using the image acquisition unit; and
a processing unit which notifies the image processing apparatus of the region to be encrypted designated by the operation unit.

9. A system according to claim 8, wherein the image processing apparatus further comprises:
an image storage unit which saves the image data acquired by the image acquisition unit, the terminal further comprises:
a display unit which displays the image data stored in the image storage unit of the image processing apparatus, and
the operation unit accepts designation of the region to be encrypted on the image data displayed on the display unit.

10. A system according to claim 8, wherein the image processing apparatus further comprises:
a signature unit which appends a digital signature to the image data acquired by the image acquisition unit; and
a transfer unit which transfers the image data appended with the signature by the signature unit to an external image storage apparatus,
the encryption unit encrypts the region to be encrypted notified by the terminal on the image data which is acquired again from the image storage apparatus,
the registration unit appends a digital signature again to the image data encrypted by the encryption unit using the digital signature unit, and registers the image data appended with the digital signature again as attachment data of the selected document data,
the terminal further comprises:
a display unit which displays the image data saved in the image storage apparatus, and
the operation unit accepts designation of the region to be encrypted on the image data displayed on the display unit.

11. An image processing method comprising:
authenticating a user;
acquiring a list of document data which are configured to be selected by the user whose authentication has succeeded;
acquiring, when one document data is selected from the acquired list of document data, image data to be attached to the selected document data; and
registering the acquired image data as attachment data of the selected document data.

12. A method according to claim 11, wherein acquiring the list includes acquiring the list of document data which are configured to be attached with image data of document data which are edited by the user whose authentication has succeeded and are stored in a specific storage device, and
registering includes registering the acquired image data as attachment data of the selected document data.

13. A method according to claim 11, wherein acquiring the list includes acquiring a list of templates as document data which are configured to be used by the user whose authentication has succeeded, and
registering includes registering the acquired image data as attachment data of document data based on the selected template.

14. A method according to claim 11, which further comprises appending a digital signature to the acquired image data,
in which registering includes registering the image data appended with the digital signature as attachment data of the selected document data.

15. A method according to claim 14, wherein appending the signature includes appending an apparatus signature which guarantees that the image processing apparatus processes to the image data, and a user signature which guarantees the user whose authentication has succeeded to the image data.

16. A method according to claim 11, which further comprises encrypting at least a partial region on the acquired image data,
in which registering includes registering the encrypted image data as attachment data of the selected document data.

17. A method according to claim 16, which further comprises extracting candidates of regions to be encrypted on the acquired image data,
in which encrypting includes encrypting a region designated from the extracted candidates of regions on the acquired image data.
